(19) United States
(12) Patent Application Publication
(10) Pub. No.: US 2013/0099726 A1
(43) Pub. Date: Apr. 25, 2013

(54) System and Method for Charging of Battery

(71) Applicants: Tao Zhang, Shanghai (CN); Jingbo Ke, San Jose, CA (US); Shungang Xu, Shanghai (CN); Shaolan Wang, Beijing (CN); Jianping Xu, Chengdu (CN)

(72) Inventors: Tao Zhang, Shanghai (CN); Jingbo Ke, San Jose, CA (US); Shungang Xu, Shanghai (CN); Shaolan Wang, Beijing (CN); Jianping Xu, Chengdu (CN)

(73) Assignee: O2MICRO, INC., Santa Clara, CA (US)

(21) Appl. No.: 13/280,934

(22) Filed: Oct. 25, 2011

(51) Int. Cl. H02J 7/00

(52) U.S. Cl. 320/107; 320/149

(57) ABSTRACT

A battery charging system for charging a battery with a plurality of battery cells. The battery charging system includes a battery charger and a battery management unit. The battery management unit includes a plurality of balancing circuits for controlling charging of each battery cell. The battery charging system can charge the battery in different stages depending on the voltage of each battery cell.

### BACKGROUND OF THE INVENTION

1. Field of the Invention

The present invention generally relates to battery, and more specifically, relates to battery charger.

2. Description of the Related Art

A battery formed by many battery cells stacked in series is becoming popular and widely used in applications such as electrical vehicle and electrical bicycle. The battery is often formed by 6, 8, or any other number of the lead-acid battery cells and delivers 6, 8, 12, or 16 volts of output voltage. In charging a battery with stacked battery cells, the battery management system often monitors the status of the battery being charged. The monitoring can sometime reach the level of individual cell. The properties of the battery most commonly monitored are voltage, current, and temperature. Because individual battery cell's physical property may differ from the physical property of a neighboring battery cell, the monitored properties may also differ from one battery cell to another.

The physical properties of each cell affect greatly the efficiency of the charging of process for each cell and for the battery as whole. Traditionally, during the charging process, a battery is connected to a power source and single charging current flows into the battery and through all the cells if the cells are stacked and connected in series. When one cell's charging efficiency drops, it will impact the charging efficiency of all the cells in the battery. As a result, some battery cell is undercharged while other battery cell may be overcharged.

Therefore, there is a need for an apparatus that enables each cell in a battery to be charged at its highest efficiency level, thus improving the overall charging efficiency of the battery.

### SUMMARY OF THE INVENTION

In one embodiment, the present invention provides a battery charging system, for charging a battery with multiple battery cells. The battery charging system includes a battery charger for outputting a charging current and a battery management unit for monitoring conditions of each battery cell during a battery charging operation and transmitting the conditions to the battery charger. The battery management unit further includes a plurality of balancing circuits, each balancing circuit having a balancing switch and a by-pass circuit, each balancing circuit being independently controlled by the battery management unit.

In another embodiment, the present invention provides a method for charging a battery with a plurality of battery cells. The method includes providing a charging current to the plurality of battery cells, the charging current being constant, monitoring a voltage from each battery cell, establishing a by-pass circuit for a battery cell if the voltage for the battery cell has reached a predefined value, providing a constant charging voltage to the plurality of battery cells if the by-pass circuit for all the battery cells have been established, and adjusting a charging voltage provided by the battery charger according to conditions received from the battery management unit if the charging current is less than a predefined value for the battery.

In yet another embodiment, the invention provides a battery management device for controlling charging a battery with multiple battery cells. The battery management device comprises a plurality of balancing circuits, each balancing circuit being connected to a battery cell, and each balancing circuit further comprises a balancing switch and a balancing resistor, wherein the balancing switch and balancing resistor forming a by-pass circuit and each balancing switch can be controlled independently from other balancing switches. Each by-pass circuit can be established independently for each balancing circuit

The present system and methods are therefore advantageous as they enable efficient charging of a battery with multiple battery cells. Other advantages and features of the present invention will become apparent after review of the hereinafter set forth Brief Description of the Drawings, Detailed Description of the Invention, and the Claims.

### BRIEF DESCRIPTION OF THE DRAWINGS

Features and advantages of embodiments of the invention will become apparent as the following detailed description proceeds, and upon reference to the drawings, where like numerals depict like elements, and in which:

FIG. 1 depicts a battery charger according to the invention;

FIG. 2 illustrates a battery charger operating with a battery management unit for charging a battery according to one embodiment of the present invention;

FIG. 3 illustrates by-pass circuits working under the first stage of a battery charging operation;

FIG. 4 illustrates the by-pass circuits working under the second stage of battery charging operation;

FIG. 5 illustrates the charging current and the voltage of the battery during the battery charging operation;

FIG. 6 illustrates the charging current and the voltage for each battery cell;

FIG. 7 illustrates a comparison of the charging current and the voltage of the battery during the battery charging operation with charging currents and charging voltages for two battery cells; and

FIG. 8 is a flowchart for battery charging operation.

### DETAIL DESCRIPTION OF THE INVENTION

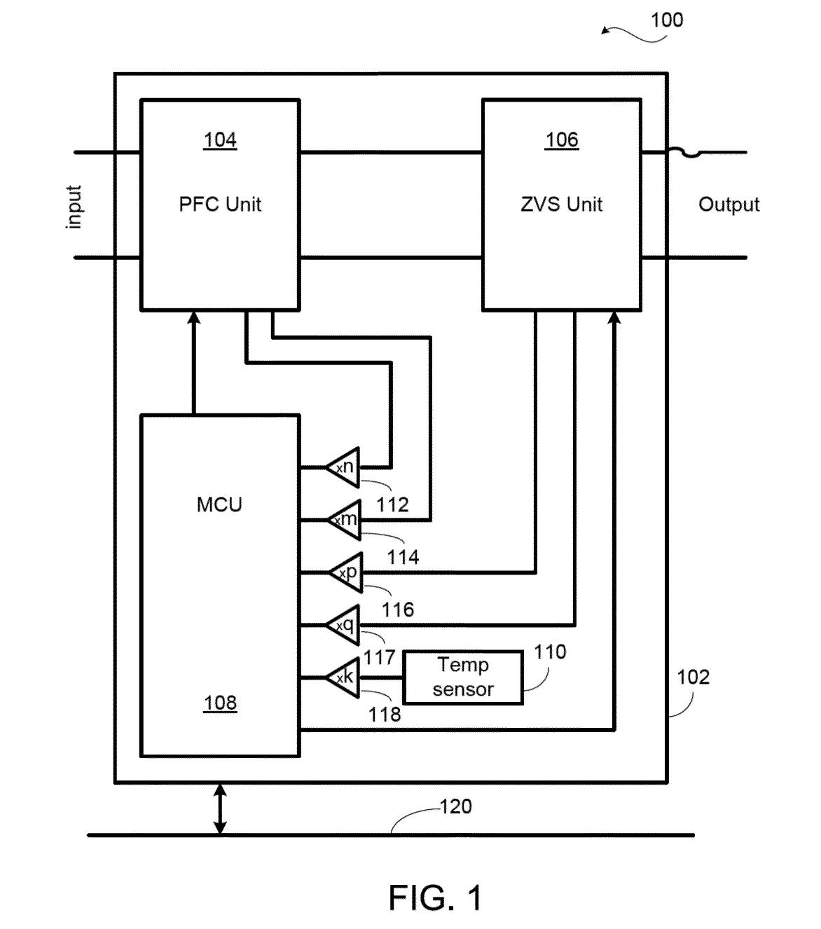

FIG. 1 is an illustration 100 of a battery charger 102 according to the invention. The battery charger 102 includes a power factor correction (PFC) unit 104, a zero voltage switch (ZVS) unit 106, and a microcontroller (MCU) 108. The PFC unit 104 connects to an input voltage source (not shown) and the ZVS unit 106 connects to an output (not shown). The MCU 108 receives through a communication bus 120 information from the battery that is being charged. The MCU 108 also monitors conditions of the PFC unit 104 and the ZVS unit 106 and controls the operations of these two units. The MCU 108 monitors the temperature of the battery charger 102 through a temperature sensor 110 and buffer 118. The MCU 108 also monitors charging current through current buffer 117 and charging voltage through voltage buffer 116. The conditions from the PFC unit 104 are also monitored. The operations of the PFC unit 104 and the ZVS unit 106 are controlled and adjusted by the MCU 108 based on the information monitored by the MCU 108.

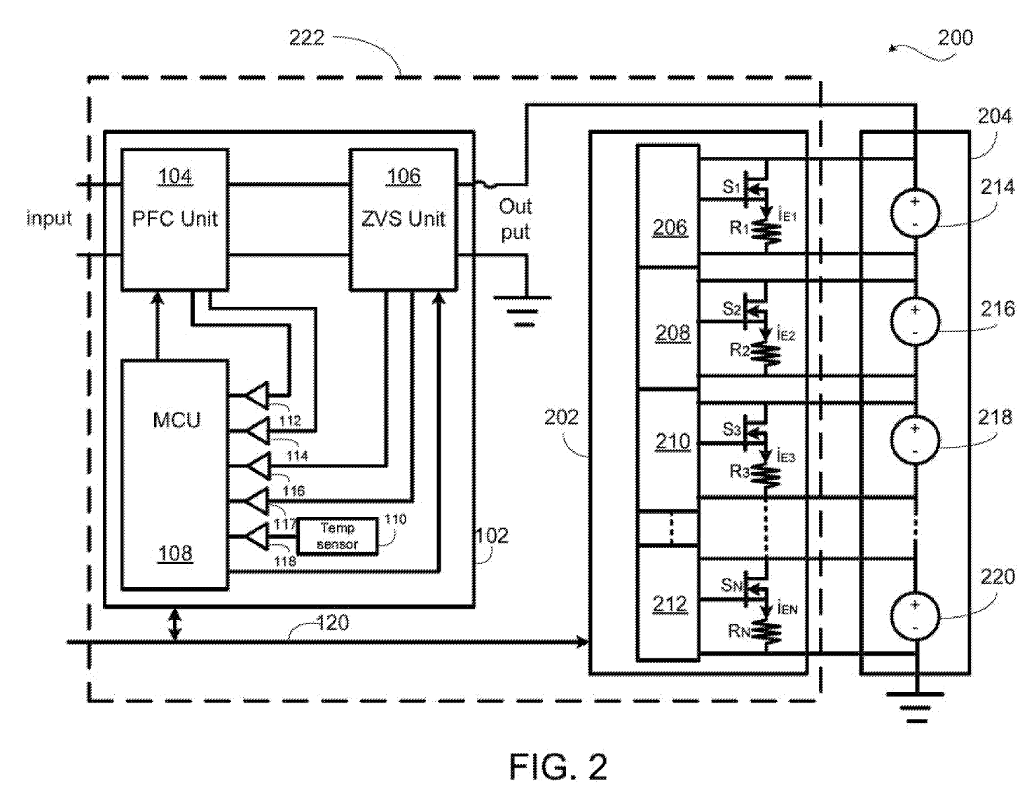

FIG. 2 is an illustration 200 of the battery charger 102 operating with a battery management (BM) unit 202 for charging a battery 204. The battery 204 has a plurality of battery cells 214, 216, 218, 220 connected in series. The battery management unit 202 includes a plurality of balancing circuits 206, 208, 210, 212, one balancing circuit for each battery cell. The balancing circuit monitors voltage, charging current, and temperature of each cell. The balancing circuit also includes a by-pass circuit. The by-pass circuit includes a balancing switch Si and a balancing resistor Ri. When the by-pass circuit is in use, a by-pass current i_{Ei} passes through the by-pass circuit. The conditions from each cell monitored by each balancing circuit are transmitted from the battery management unit 202 in real time to the battery charger 102 through the communication bus 120. The MCU 108 in the battery charger 102 uses the information received from the battery management unit 202 to control the output of the battery charger 102. By controlling the operation of the balancing switch, opening and closing the balancing switch and establishing the by-pass circuit, the balancing circuit can control the charging current going into each cell. Each of the plurality of the balancing circuits, 206, 208, 210, or 212, can be controlled independently by the battery management unit 202, i.e., one balancing switch, Sₙ (1≦n≦N) may be closed while an adjacent balancing switch Sₙ₊₁ may be open. By operating independently each balancing circuit, each battery cell may be charged under the best condition for that battery cell and for the battery charger 102 and the BM unit 202. Though the battery charger 102 and the battery management unit 202 are shown as separate units in FIG. 2, the battery charger 102 and the battery management unit 202 form a battery charging system 222 and can be built into one integrated circuit or one single chip.

The operation of each balancing circuit is controlled by the MCU 108 in the battery charger 102. The MCU 108 determines whether a balancing switch of a balancing circuit should be open or closed based on the information received from the corresponding battery cell, i.e., the voltage, the charging current, and the temperature of the corresponding battery cell. The MCU 108 determines the best operating condition for the battery charger 102 and the battery management unit 202, then the MCU 108 can instruct the ZVS unit 106 to output an ideal output current and also instruct each balancing circuit, 206, 208, 210, or 212, to either open or close the balancing switch Sᵢ. The MCU 108 sends instructions to each balancing circuit through the communication bus 120.

For the subsequent description of the operation of the present invention, following definitions and assumptions are made.
The balancing resistors Rᵢ in the battery management unit 202 are preferably the same, i.e.,

R₁=R₂=R₃= . . . =R_{N}=R;
The voltage in each cell is denoted as

V_{cell1}≈V_{cell2}≈ . . . ≈V_{celln}≈ . . . ≈V_{cellN}≈V_{cell-avg},
where V_{cell-avg} is the average voltage for each battery cell;
The best constant charging voltage for one single battery cell is denoted as V_{cell-cv};
the best floating charging voltage for one single battery cell is denoted as V_{cell-fc};
The maximum by-pass current provided by each balancing circuit is

$$iE \text{-} max = \frac{Vcell \text{-} cv}{R}$$

The maximum charge current for each battery cell is i_{Ch-max};
The charging current provided by the battery charger 102 is i_{charge}.

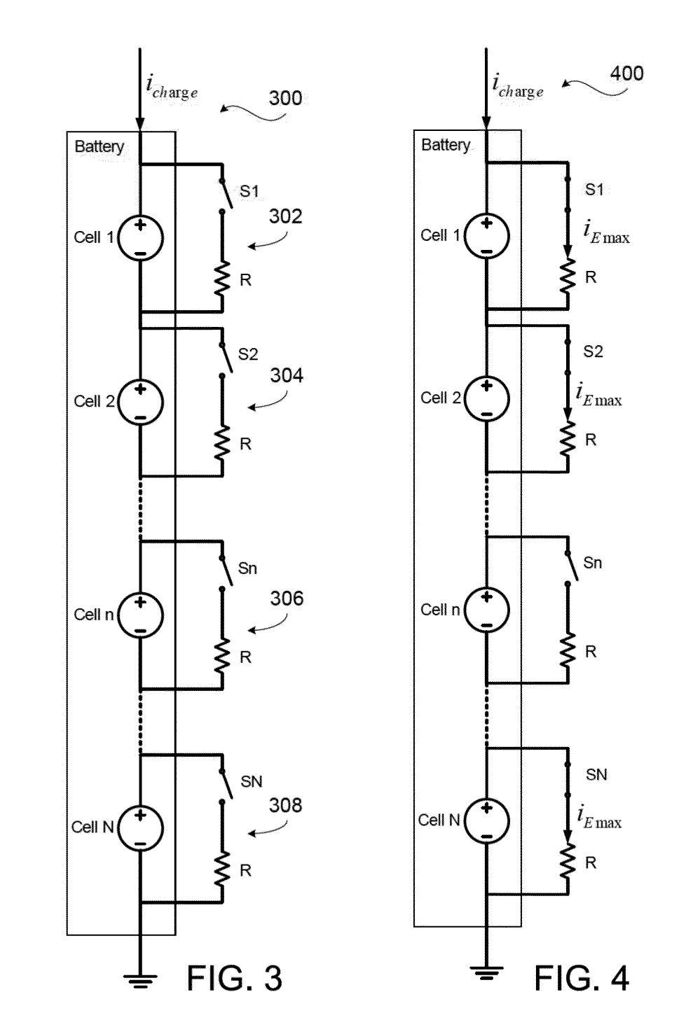

The battery charging operation using the battery charging system of the present invention can be divided into four stages. In the first stage, the constant charging current stage, the battery cells are charged with a maximum charging current under a best constant charging voltage. At the beginning of a battery charging process, every cell in a battery has low remaining charge, and the voltage at each cell is lower than the best constant charging voltage V_{cell-cv}. So, the battery charging system 222 can charge the battery 204 using the maximum charging current for each individual cell i_{Ch-max} and at this time the maximum output current from the battery charger 102 is i_{charge}=i_{Ch-max}. FIG. 3 is an illustration 300 of the by-pass circuits 302, 304, 306, 308 in each balancing circuit during the first stage. The operation of the by-pass circuits are under control of the battery management unit 202. All the balancing switches S₁, S₂, . . . , S_{N} are open and the cell voltage for each battery cell V_{cell1}, V_{cell2}, . . . , V_{celln}, . . . , V_{cellN} are lower than the best constant charging voltage V_{cell-cv}. The current passing through each battery cell is the maximum charge current i_{Ch-max}.

As the battery cells are charged under the constant charging current, a first battery cell will reach the best constant charging voltage V_{cell-cv} and the battery charging operation will enter the second stage. In the second stage, when the voltage in any battery cell reaches V_{cell-cv}, the battery management unit 202 will close the balancing switch Si and the by-pass circuit is established for that battery cell and part of the charging current i_{charge} is diverted onto that by-pass circuit. The battery management unit 202 tracks which balancing switch has closed and also which is the highest charging voltage among all the battery cells. The battery management unit 202 will close the balancing switch of the battery cell that has the highest charging voltage. By closing the balancing switch, thus diverting some charging current to the by-pass circuit, the charging voltage for this battery cell is lowered to the best constant charging voltage V_{cell-cv}. The charging current i_{charge} provided by the ZVS unit 106 is set to the maximum charge current i_{Ch-max} for the battery cell that has the highest charging voltage. During the second stage, when a battery cell reaches the best constant charging voltage V_{cell-cv} and the balancing switch Si closes, part of the charging current is diverted onto the by-pass circuit. The maximum by-pass current is i_{E-max} and the battery charging current flowing through the battery cell is i_{charge}−i_{E-max}. Because the battery charging current is decreased by i_{E-max}, the voltage for that battery cell also drops to less than V_{cell-cv}. The battery charging current i_{charge-i} for that particular battery cell is

i_{E-max}<i_{charge-i}<i_{Ch-max}

During the second stage, the partial constant charging current stage, for the battery cells that have reached the best constant charging voltage, the charging will continue with the constant charging voltage that will not exceed the best constant charging voltage. For the battery cells that have not reached the best constant charging voltage, the charging will continue with the constant charging current as in the first stage. When the voltage of the battery cell drops to less than V_{cell-cv}, the balancing switch will open and let more charging current into the battery cell, which in turn will raise the voltage of that battery cell. Again, the balancing switch will close. The balancing switch will open and close repeatedly; initially the balancing switch will stay longer time open, but gradually the timing will change and the balancing switch will stay close for longer period of time as the voltage of the battery cell approaches the best constant charging voltage.

For the battery cells that have closed the balancing switches Si, the battery charging current is i_{charge}−i_{E-max}; because i_{charge}−i_{E-max} is the charging current for the battery cell with the highest battery cell voltage, therefore the battery charging current i_{charge}−i_{E-max} is the maximum battery charging current for all the battery cells that have their balancing switches closed and this battery charging current will not cause overcharging of the battery cells.

For the battery cells that have not closed the balancing switches Si, the charging current i_{charge} satisfies the condition of i_{E-max}<i_{charge}<i_{Ch-max}. The charging current i_{charge} is the maximum current that will not cause overcharging condition in any of the battery cells. Therefore, the charging of the battery cells may be at the maximum speed without overcharging. FIG. 4 is an illustration 400 of charging of a battery with multiple battery cells, where some battery cells have their balancing switches closed and some cells have not.

During the battery charging operation, all the battery cells that have the balancing switches closed are charged under constant voltage condition or near the constant voltage condition, while the battery cells that have not closed their balancing switches are charged with a charging current that continuously adapts to the battery cell condition and the voltages for these battery cells with open balancing switches continue to increase until the battery cell voltage for each battery cell reaches the best constant charging voltage V_{cell-cv} at which time the balancing switch for the battery cell reaching the best constant charging voltage will be closed and the battery cell will then enter the constant voltage charging mode.

After all the balancing switches Sᵢ for all the battery cells have closed at least once, the battery charging operation enters the third stage, the constant charging voltage stage, during which the battery cells will be charged under the constant voltage and the balancing switch Sᵢ for each battery cell will be open or closed according to the voltage of that battery cell. During the third stage, the charging voltage for the battery 204 equals to the best constant charging voltage V_{cell-cv} multiplied by the number of the battery cells and the maximum charging current is limited by the maximum charging current provided by the balancing circuit, i.e., i_{charge}<i_{E-max}. Each balancing switch Sᵢ is open or closed in real time depending on whether the voltage of the corresponding battery cell has exceeded the best constant charging voltage. As the balancing switches open and close, the average charging current drops continuously. During the third stage, when the voltage of one battery cell rises above the best constant charging voltage for that battery cell, the balancing circuit for that battery cell starts to operate. The balancing circuit will maintain a charging current i_{ch-celln} to be between 0 and i_{E-max}, i.e., 0<i_{ch-celln}<i_{E-max}. Since the maximum charging current is limited to the maximum balancing circuit current, i.e., i_{charge}<i_{E-max}, therefore the battery management unit can ensure that no battery cell will be overcharged. During the third stage, when the battery is being charged under a constant voltage, the total charging current from the battery charger 102 equals to the maximum of all the charging currents for all the battery cells. For other battery cells that operate with lower charging currents, part of the total charging current flows through the by-pass circuit. Therefore, the battery management unit 202 can ensure each battery cell is charged by the maximum charging current acceptable for that particular battery cell, and as consequence, each battery cell will be charged under the most efficient condition.

When the average charging current for the battery 204 drops below a predefined level, for example 0.02 C (the predefined level is usually provided by battery manufacturer), i_{charge}<i_{E-max}, the charging mode for the battery cell switches to the fourth stage, the floating charging mode. The “C” in the example 0.02C refers to the capacity of the battery. If the capacity of the battery is 200 Ah, then 0.02C equals 4A (0.02×200=4).

When the total charging current is less than the predefined level, e.g., 0.02 C, the battery charging operation enters the fourth stage, the floating charging voltage stage, and the battery is charged under a floating voltage. The balancing switch for each battery cell operates according to the voltage of that particular battery cell and the operation is adjusted in real time, i.e., the charging voltage is not fixed. During the fourth stage, the charging voltage for the battery equals to the best floating charging voltage for one single battery cell V_{cell-fc} times the number of the battery cells. The charging current is limited by the maximum balancing current allowed by a balancing circuit, i.e., i_{charge}<i_{E-max}.

During the fourth stage, if the voltage of a battery cell n rises above the best floating charging current, V_{cell-fc}, for the battery cell n, the balancing circuit for the battery cell n will start to operate and the charging current i_{ch-celln} for the battery cell n is kept at 0<i_{ch-celln}<i_{E-max}. The charging voltage during this fourth stage is floating because it is constantly adjusted. Since the maximum charging current is limited to the maximum balancing circuit current, i.e., i_{charge}<i_{E-max}, therefore the battery management unit can ensure that no battery cell will be overcharged. During the fourth stage, when the battery is charged under floating charging voltage, the total charging current i_{charge} equals to the maximum charging current among all the charging currents for all the battery cells. For battery cells that require less than the total charging current i_{charge}, part of the total charging current flows through the by-pass circuit. Thus, the battery manage unit 202 will assure that each cell is charged under the floating charging voltage with the maximum charging current that cell can accept.

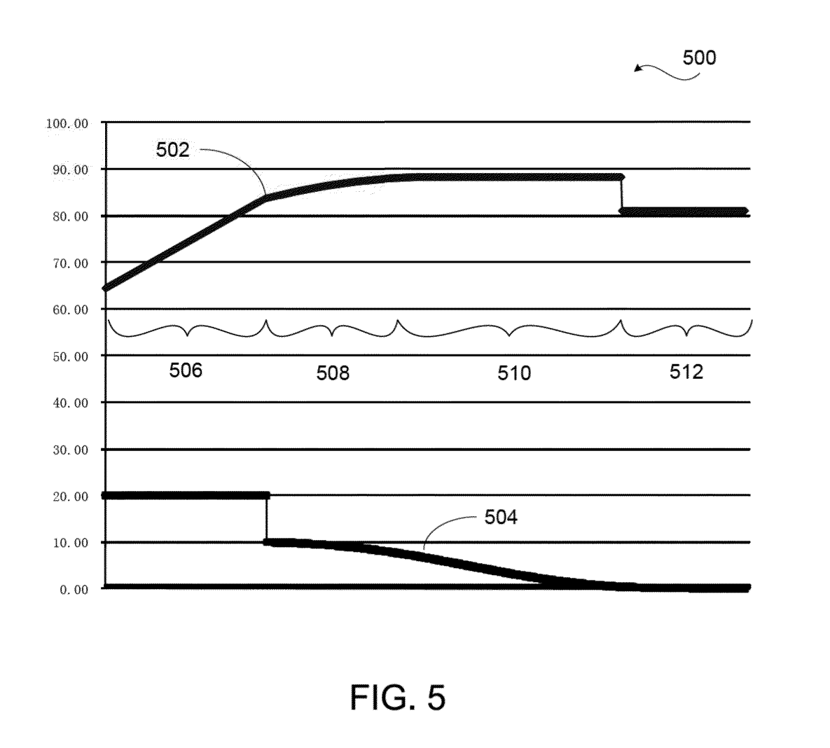

FIG. 5 is a chart 500 illustrating the battery charging voltage 502 and the battery charging current 504 during a battery charging operation. During the first stage 506 when the battery is charged under a maximum charging current, it can be seen that the voltage 502 rises rapidly while the battery charging current 504 maintains constant. During the second stage 508 when some balancing switches are closed, the voltage 502 rises in a slower speed and the battery charging current 504 slowly drops. During the third stage 510, the battery cell is charged under constant voltage and the voltage 502 remains almost constant and the battery charging current 504 continues to drop. During the fourth stage 512, the battery charging current 504 is very small and the battery charging voltage 502 floats around a voltage necessary to maintain the battery charging current 504.

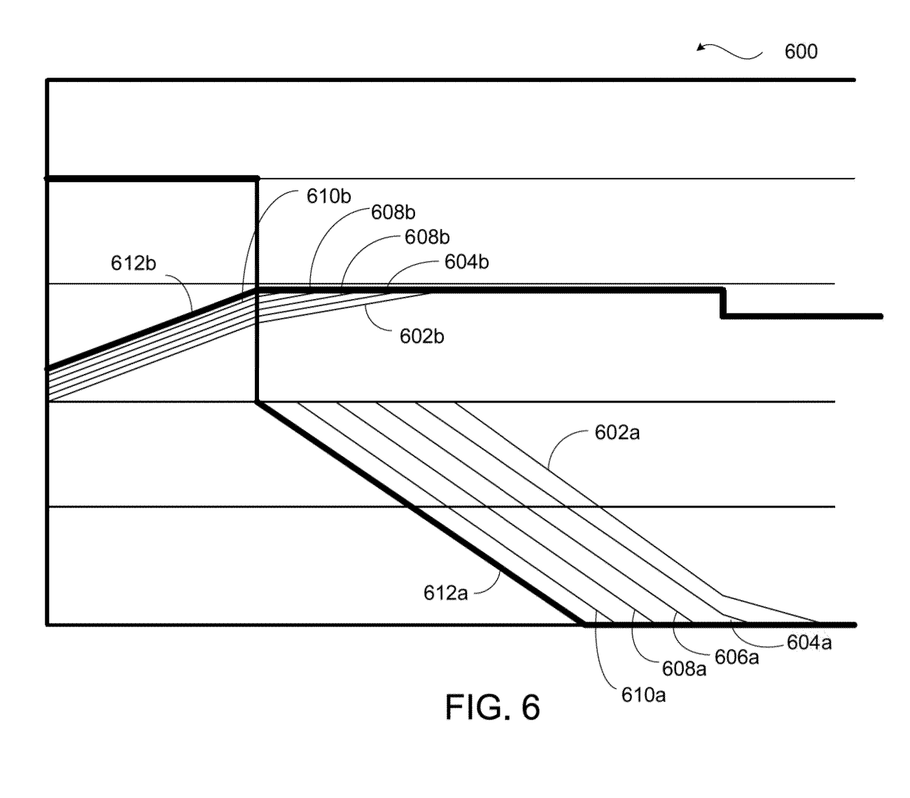

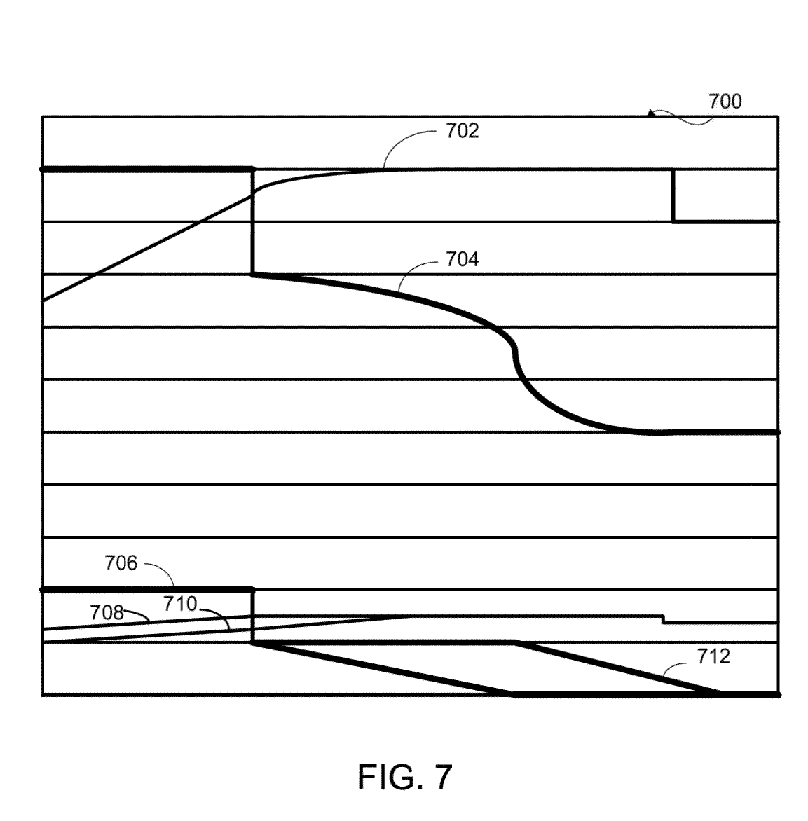

FIG. 6 is a chart 600 that illustrates the battery voltages 602b, 604b, 606b, 608b, 610b, and 612b and the charging currents 602a, 604a, 606a, 608a, 610a, and 612a for the battery cells. The battery voltage lines have roughly the same shape as the battery charging voltage 502 from FIG. 5 and the charging currents have roughly the same shape as the battery charging current 504 of FIG. 5. This similarity is further shown in the chart 700 in FIG. 7

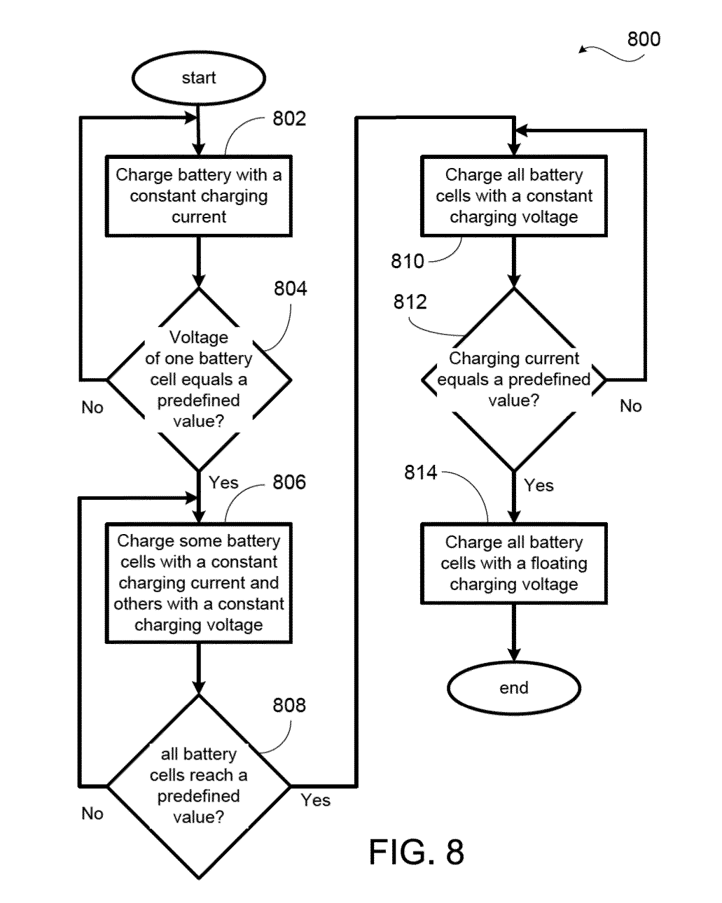

FIG. 8 is a flowchart 800 for the operation of the battery charging system 222. The battery charging system 222 starts to charge a battery 204 with multiple battery cells in the constant charging current mode, 802, and the battery management unit 202 constantly monitors the charging condition for each battery cell, 804. If the voltage of one battery cell reaches the best constant charging voltage, the battery charging system 222 starts to charge some battery cell with a constant current and some battery cell with constant voltage, 806. As more battery cells reach the best constant charging voltage, the charging current will drops slowly as these battery cells start to charge under the constant voltage. If all the battery cells have reached the best constant charging voltage, 808, the battery charging system 222 start to charge all the battery cells under the best constant charging voltage, 810. The charging current will drop continuously until the charging current is equal or less than a predefined value, 812, then the battery charging system 222 will start to charge the battery cells under a floating voltage, 814.

FIGS. 5, 6, and 7 are for illustration purpose only. The graphics in these figures are taken from measuring a 72 V battery and they illustrate the general behavior of battery cell voltages and charging currents.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated.

What is claimed is:

1. A battery charging system, for charging a battery with multiple battery cells, comprising:
a battery charger for outputting a charging current; and
a battery management unit, in communication with the battery charger, for monitoring conditions of each battery cell during a battery charging operation and transmitting the conditions to the battery charger,
wherein the battery management unit further comprising a plurality of balancing circuits, each balancing circuit having a by-pass circuit with a balancing switch, each balancing circuit being independently controlled by the battery management unit.

2. The control system of claim 1, wherein the battery charger further comprising:
a power factor correction unit for connecting to a voltage source;
a zero voltage switch unit for outputting a charging current; and
a microcontroller for receiving the conditions and for controlling the zero voltage switch unit and the battery management unit.

3. The control system of claim 1, wherein the by-pass circuit for a balancing circuit is established when the balancing switch for the corresponding balancing circuit is closed.

4. The control system of claim 1, wherein the battery charger is configured to operate in four stages.

5. The control system of claim 4, wherein the four stages comprises constant charging current stage, constant charging voltage stage, floating charging voltage stage, and partial constant charging current stage.

6. The control system of claim 5, wherein, during the constant charging current stage, the battery management unit is configured to open every balancing switch.

7. The control system of claim 5, wherein the partial constant charging current stage is entered when a voltage of a first battery cell reaches a predefined value.

8. The control system of claim 5, wherein the constant charging voltage stage is entered when the balancing switch of each balancing circuit has closed at least once.

9. The control system of claim 5, wherein the floating charging voltage stage is entered when the charging current is less than a value predefined by a manufacturer of the battery.

10. The control system of claim 5, wherein the floating charging voltage stage is entered when the battery management unit is configured to close every balancing switch at least once.

11. A method, for charging a battery with a plurality of battery cells, comprising the steps of:
providing, by a battery charger, a charging current to the plurality of battery cells, the charging current being constant;
monitoring, by a battery management unit, a voltage from each battery cell;
establishing a by-pass circuit for a battery cell if the voltage for the battery cell has reached a predefined value;
providing, by the battery charger, a constant charging voltage to the plurality of battery cells if the by-pass circuit for all the battery cells have been established; and
adjusting, by a microcontroller, a charging voltage provided by the battery charger according to conditions received from the battery management unit if the charging current is less than a predefined value for the battery.

12. The method of claim 11 further comprising the step of closing, by the battery management unit, a balancing switch for the battery cell which voltage has reached the predefined value.

13. The method of claim 11 further comprising the step of opening, by the battery management unit, the balancing switch for the battery cell which voltage has dropped below the predefined value.

14. The method of claim 7 further comprising the step of opening and closing a balancing switch for a battery cell according to the voltage of that battery cell.

15. A battery management device, for controlling charging a battery with multiple battery cells, comprising a plurality of balancing circuits, each balancing circuit being connected to a battery cell, each balancing circuit further comprising:
a balancing switch; and
a balancing resistor,
wherein the balancing switch and balancing resistor form a by-pass circuit, each balancing switch can be controlled independently from other balancing switches, each by-pass circuit can be established independently for each balancing circuit.

16. The battery management device of claim 11, wherein the battery management device sends and receives information from a battery charger.
